(19) United States
(12) Patent Application Publication
(10) Pub. No.: US 2008/0017252 A1
(43) Pub. Date: Jan. 24, 2008

(54) Electronic control device for a pump

(75) Inventor: Otto Varini, Suzzara (IT)

Correspondence Address: MODIANO & ASSOCIATI, Via Meravigli, 16, MILAN, 20123, omitted

(73) Assignee: PIUSI S.p.A.

(21) Appl. No.: 11/826,053

(22) Filed: Jul. 12, 2007

(30) Foreign Application Priority Data
Jul. 20, 2006 (IT) MI2006A001417

(51) Int. Cl. G05D 9/12

(52) U.S. Cl. 137/392

(57) ABSTRACT

An electronic control device for a pump, particularly for transferring liquids, comprising a central control unit, which is adapted to drive an electric motor which is designed to operate the pump, at least one motor temperature sensor, which is adapted to send a temperature signal to the control unit, at least one motor current sensor, which is adapted to send a current signal to the motor, and at least one power switch, which is adapted to drive the motor, the power switch being driven by the control unit in order to control the motor according to the signals of the temperature sensor and the current sensor.

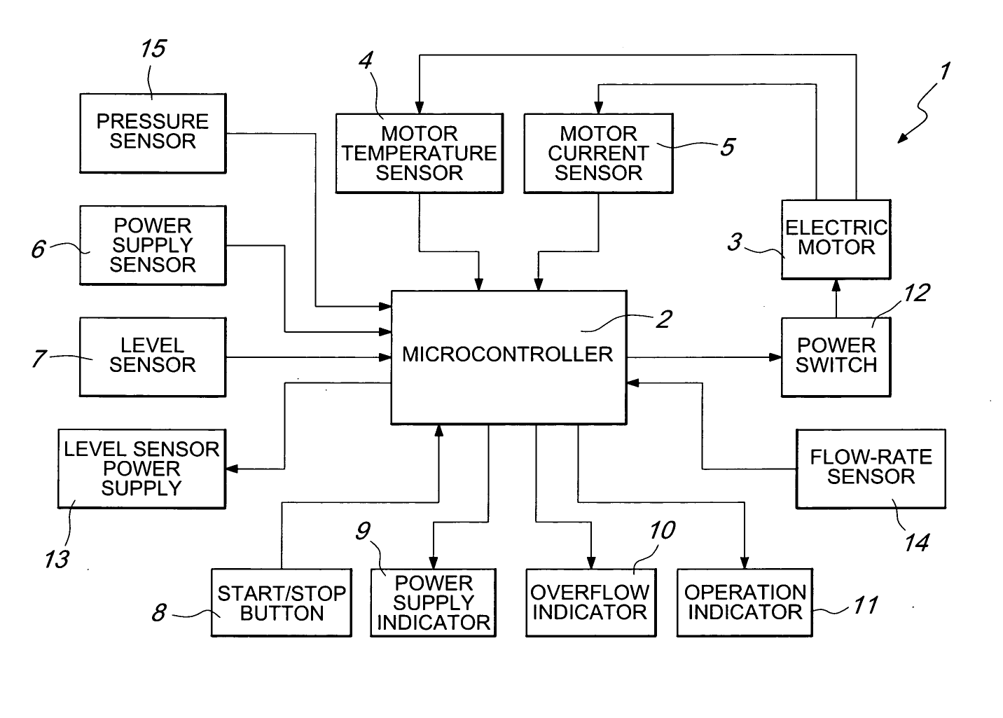

The present invention relates to an electronic device for controlling a pump, particularly for transferring fuels, lubricants and liquids in general, with a variable-supply electric motor.

### BACKGROUND OF THE INVENTION

More particularly, the invention relates to an electronic device for controlling a pump in which the electric motor is undersized.

As is known, ordinary pumps, for example for transferring liquids, in some cases have an electric motor with a variable power supply.

Usually, the motor of the pump must be sized so that after a certain period of operation of the pump it does not tend to reach temperatures which are critical for the motor.

The possibility to use an undersized motor on a pump of this kind would lead to evident advantages in terms of costs and space occupation, but of course this is currently not possible, because undersizing the motor would cause the drawback that after a certain period of time of operation of the pump, such pump would reach a temperature which would be critical for the motor and the delivery of the pump would not be able to continue correctly.

### SUMMARY OF THE INVENTION

The aim of the present invention is to provide an electronic control device for a pump which allows to maximize the efficiency of the pump in any operating situation.

Within this aim, an object of the present invention is to use an undersized motor as the motor of the pump.

Another object of the present invention is to provide an electronic control device for a pump which prevents the undersizing of the motor from leading to drawbacks for such motor after a certain period of operation of the pump, as the operating temperatures increase.

Another object of the present invention is to provide an electronic control device for a pump which integrates a motor temperature control.

Still another object of the present invention is to provide an electronic control device for a pump which is highly reliable, relatively simple to provide and at competitive costs.

This aim and these and other objects, which will become better apparent hereinafter, are achieved by an electronic control device for a pump, particularly for transferring fuels, lubricants and liquids in general, characterized in that it comprises a central control unit, adapted to drive an electric motor which is designed to operate the pump, at least one motor temperature sensor, adapted to send a temperature signal to said control unit, at least one motor current sensor, adapted to send a current signal to said motor, and at least one power switch adapted to drive said motor, said power switch being driven by said control unit in order to control the motor according to the signals of said temperature sensor and said current sensor.

### BRIEF DESCRIPTION OF THE DRAWINGS

Further characteristics and advantages of the invention will become better apparent from the description of a preferred but not exclusive embodiment of the device according to the present invention, illustrated by way of non-limiting example in the accompanying drawing, wherein the only FIGURE is a block diagram of the control device according to the present invention.

### DESCRIPTION OF THE PREFERRED EMBODIMENTS

With reference to the FIGURE, the control device according to the present invention, generally designated by the reference numeral 1, is particularly adapted for controlling a pump, for example for transferring fuels, lubricants and liquids in general, which is powered by an electric motor with variable power supply and comprises a central control unit or microcontroller 2.

The microcontroller manages a number of items of information which arrive from sensors which are arranged within the pump and detect data in order to be able to drive optimally an electric motor 3 which is designed to operate the pump.

The motor 3 is suitably undersized. The term “undersizing” references the use of an electric motor, to operate the pump, the operation whereof would not be normally ensured when the pump reaches its maximum operating temperature, since such maximum temperature would be a critical temperature for the motor.

The control device according to the invention obviates this drawback by allowing to use an undersized motor, controlling the temperature appropriately, as discussed in detail hereinafter.

The control device according to the invention therefore has at least one electric motor temperature sensor 4, which sends to the microcontroller 2 a temperature signal which is taken from the motor 3.

The device further has at least one electric motor current sensor 5, which is adapted to send a current signal to the microcontroller 2.

The device further has a power supply sensor 6, which is adapted to detect the voltage in input to the control device and to send a voltage signal to the microcontroller 2, and a level sensor 7, which sends a signal to the microcontroller 2.

The device is further provided with a start/stop button 8 and with a series of indicators, including for example a power supply indicator 9, an overflow indicator 10 for a tank to which the pump is feeding a fluid, and an operation indicator 11.

The electric motor 3 is controlled by a power switch 12, for example a MOSFET, which is driven by the microcontroller 2.

The microcontroller 2 emits in output, in addition to the control signal of the power switch 12, a power supply signal for a level sensor 13, which is adapted to determine the level of the fluid reached within a tank to which the pump is delivering fluid.

In the FIGURE, the pump is not shown, since the illustrated device is simply arranged on an electronic board which is located on board the pump itself.

The device further comprises at least one pressure sensor 15, adapted to send to said control unit a liquid pressure signal, and at least one flow-rate sensor 14, adapted to send a liquid flow-rate signal to said control unit.

The advantages of the device are as follows.

Self-calibration of the electronic board depending on the power supply voltage, for example 12 V DC or 24 V DC.

Moreover, depending on the motor temperature control, there is, by means of the logic system provided within the microcontroller 2, a reduction of the current fed to the motor, down to power-off in case of an excessive temperature.

Control of the current by means of the sensor 5 instead allows immediate halting in case of an overcurrent caused for example by jamming of the rotor or due to an interruption of the pump if there is no priming of fluid.

Pump halting also occurs if the level sensor, for example a tank-full contact, is tripped.

Conveniently, the level sensor 7 can be an optical sensor which is powered by such board by means of the control unit or microcontroller 2, block 13 of the FIGURE.

The intervention of the overflow indicator 10 leads to a stop of the pump.

Conveniently, the overflow sensor can be provided by means of an optical sensor.

The start/stop button 8 allows to act on the driving of the power switch 12. To interrupt the operation of the pump it is sufficient to press button 8, and the same applies for restarting it.

If the cause of the stop was the current drawn by the motor, or the temperature reached by the motor, by simply pressing the start/stop button 8 the pump restarts, although if the cause of the stop persists, the operation of the pump may last a few minutes or a few seconds.

If the cause of the stop was instead the signal that arrived from the overflow indicator 10, even if the button 8 is operated the pump does not restart, since the tank that the pump is filling is already full.

Substantially, therefore, the electronic device according to the invention allows to control electronically the operation of the pump by using in particular a pump motor temperature sensor and a motor current sensor, and therefore to drive said motor depending on the acquired temperature and current data. Moreover, control of the motor 3 occurs according to the signal that arrives from the level sensor 7.

This, therefore, also allows to use even an undersized motor, since it is possible to act on the operation of said motor in case of particular conditions, without causing an unwanted halting of the pump.

Substantially, when the temperature of the pump reaches a critical level, which can be detected by means of a monitoring of the temperature of the motor itself, the microcontroller reduces the supply voltage of the motor, thus ensuring that the pump ends the delivery without problems.

The device further allows to keep the delivery flow-rate constant regardless of the external conditions and according to the performance limitations of the motor.

The device allows to protect the pump against failures caused by lack of priming, by overpressure on the delivery circuit, by overheating due to careless use on the part of the user, and moreover the control unit stores the operating data and, if interfaced appropriately, allows to download a file with the logged data to allow inspections.

In practice it has been found that the control device according to the present invention fully achieves the intended aim and objects, since it allows to use, for an ordinary pump, a motor which is undersized for the pump despite being able to ensure correct operation thereof.

The device thus conceived is susceptible of numerous modifications and variations, all of which are within the scope of the appended claims; all the details may further be replaced with other technically equivalent elements.

The disclosures in Italian Patent Application No. MI2006A001417 from which this application claims priority are incorporated herein by reference.

What is claimed is:

1. An electronic control device for a pump, particularly for transferring fuels, lubricants and liquids in general, comprising a central control unit, which is adapted to drive an electric motor which is designed to operate the pump, at least one motor temperature sensor, which is adapted to send a temperature signal to said control unit, at least one motor current sensor, which is adapted to send a current signal to said motor, and at least one power switch, which is adapted to drive said motor, said power switch being driven by said control unit in order to control the motor according to the signals of said temperature sensor and said current sensor.

2. The device according to claim 1, comprising a power supply sensor which is adapted to send a power supply voltage signal to said control unit.

3. The device according to claim 1, comprising on said control unit, an input for a signal which arrives from a level sensor of a tank.

4. The device according to claim 1, wherein said electric motor has a variable power supply and is undersized.

5. The device according to claim 1, wherein said control unit emits in output a power supply signal for said level sensor.

6. The device according to claim 1, comprising a button for starting/stopping said pump.

7. The device according to claim 1, comprising a plurality of indicators for controlling said pump and said tank.

8. The device according to claim 1, further comprising at least one pressure sensor, which is adapted to send a liquid pressure signal to said control unit.

9. The device according to claim 1, comprising at least one flow-rate sensor which is adapted to send a liquid flow-rate signal to said control unit.

10. A pump particularly of the type for transferring liquids, comprising an undersized electric motor and a control device according to claim 1.
